(19) United States
(12) Patent Application Publication
(10) Pub. No.: US 2012/0174589 A1
(43) Pub. Date: Jul. 12, 2012

(54) Combustion Chamber End Cover Without Welding or Brazing

(76) Inventors: Donald Mark Bailey, Simpsonville, SC (US); Patrick Benedict Melton, Horse Shoe, NC (US); William Lawrence Byrne, Simpsonville, SC (US)

(21) Appl. No.: 12/986,611

(22) Filed: Jan. 7, 2011

(51) Int. Cl. F02C 7/22; F02C 7/00

(52) U.S. Cl. 60/746; 60/722

(57) ABSTRACT

An end cover assembly is provided in combination with a gas turbine combustor for capping a back end of a combustion chamber. The end cover assembly includes an end cover plate securable to the back end of the combustion chamber, and a monolith block secured to the end cover plate. The end cover plate is constructed without welded gas passage plates and without brazed flow passage inserts and includes fuel channels therethrough, where the fuel channels are sized and positioned to interact with fuel nozzle inlet ports. The monolith block includes internal fuel gas passages positioned relative to the fuel channels in the end cover plate to commute fuel gas to the fuel channels of the end cover plate.

### BACKGROUND OF THE INVENTION

The invention relates to gas turbines and, more particularly, to an end cover assembly for capping a back end of a combustion chamber.

Existing end covers for capping the back end of a combustion chamber have durability issues due to the complexity of the end cover construction. The end cover is typically formed of a thick plate that commutes multiple fuel gas passages to fuel nozzles of the combustor with internal passages. In a typical construction, the end cover includes welded plates that create an internal pocket for fuel passages and/or brazed inserts such as fuel flow adapters to channel fuel gas to multiple passages on the nozzles. In addition to the long-term durability issues, the complex design is expensive to manufacture.

It would be desirable to design an end cover assembly that eliminates welding and/or brazing to reduce the durability issues and to simplify the construction.

### BRIEF DESCRIPTION OF THE INVENTION

In an exemplary embodiment, an end cover assembly caps a back end of a combustion chamber. The end cover assembly includes an end cover plate securable to the back end of the combustion chamber, and a monolith block secured to the end cover plate. The end cover plate is a one piece member with fuel channels therethrough, where the fuel channels are sized and positioned to interact with fuel nozzle inlet ports. The monolith block includes internal fuel gas passages positioned relative to the fuel channels in the end cover plate to commute fuel gas to the fuel channels of the end cover plate.

In another exemplary embodiment, a gas turbine combustor includes a casing with a combustion chamber, a plurality of fuel nozzles disposed in the casing adjacent the combustion chamber, and the end cover assembly of the described embodiments secured to the casing and capping a back end of the combustion chamber.

In yet another exemplary embodiment, an end cover assembly is provided in combination with a gas turbine combustor for capping a back end of a combustion chamber. The end cover assembly includes an end cover plate securable to the back end of the combustion chamber, and a monolith block secured to the end cover plate. The end cover plate is constructed without welded gas passage plates and without brazed flow passage inserts and includes fuel channels therethrough, where the fuel channels are sized and positioned to interact with fuel nozzle inlet ports. The monolith block includes internal fuel gas passages positioned relative to the fuel channels in the end cover plate to commute fuel gas to the fuel channels of the end cover plate.

### BRIEF DESCRIPTION OF THE DRAWINGS

FIG. 1 is a sectional view through a gas turbine combustor;

FIG. 2 is a sectional view showing details of the end cover assembly;

FIG. 3 is an alternative sectional view of the end cover assembly; and

FIG. 4 is a perspective view of the end cover assembly.

### DETAILED DESCRIPTION OF THE INVENTION

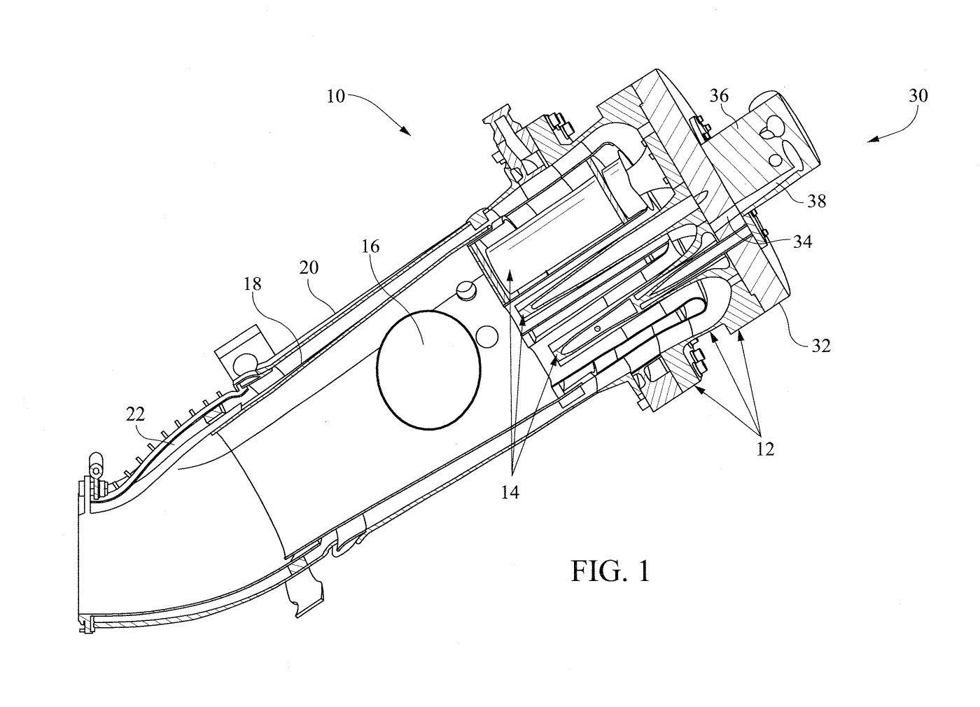

The combustion system of a gas turbine generates hot gases to drive a turbine. The turbine, in turn, drives a compressor that provides compressed air for combustion in the combustion system. The turbine also produces usable output power. A combustion system for a gas turbine may be configured as a circular array of combustion chambers arranged to receive compressed air from the compressor, inject fuel into the compressed air to create a combustion reaction, and generate hot combustion gases for the turbine. FIG. 1 is a sectional view of a cylindrical combustion chamber 10. The assembly is housed in a casing 12 and includes a plurality of fuel nozzles 14. In a typical construction, a plurality of outer fuel nozzles (e.g., five outer fuel nozzles) surround a center fuel nozzle. A combustion zone 16 downstream of the fuel nozzles 14 is provided within a combustion liner 18, and a flow sleeve 20 is provided surrounding and radially spaced from the liner 18. The products of combustion are directed to the turbine via a gas transition duct 22.

As noted, in a typical construction, an end cover plate assembly bolts to the forward casing and contains the pressure and flow on the forwardmost end of the combustor assembly. The end cover assembly of the described embodiments is modified from the conventional welded and/or brazed assembly into a two component bolted assembly.

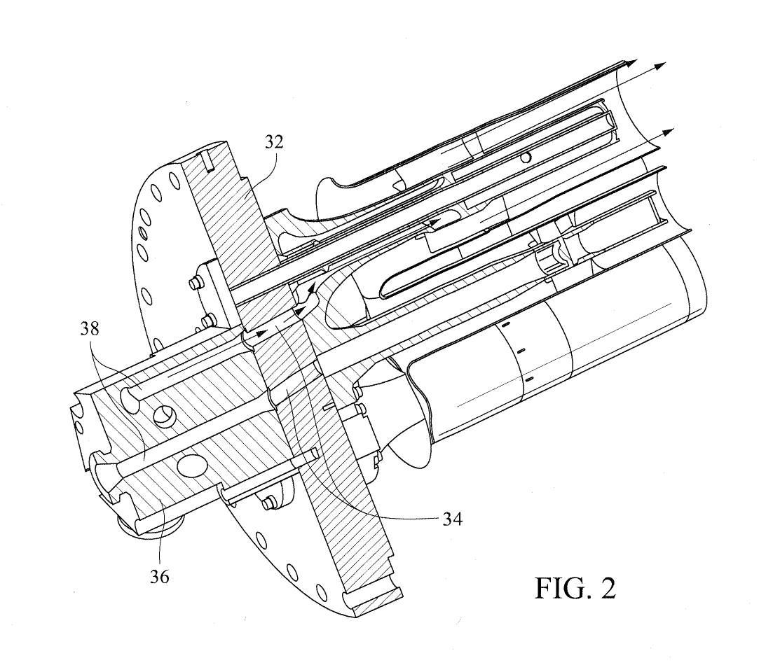

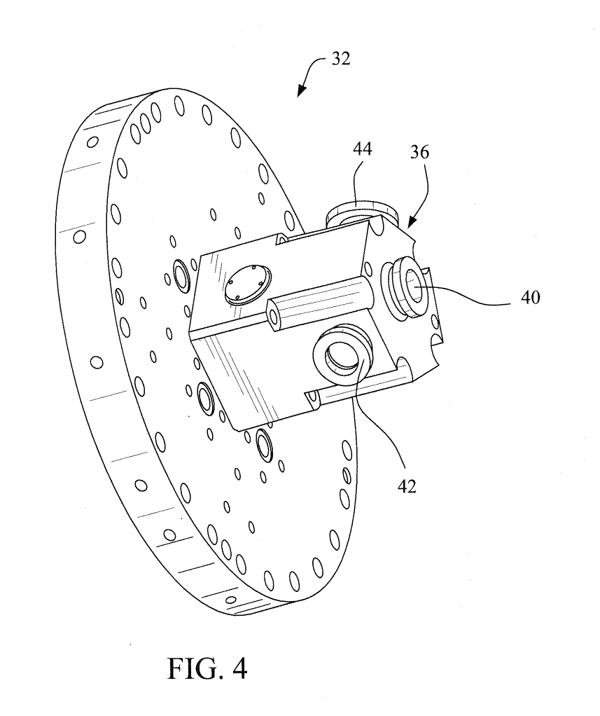

With reference to FIGS. 1-4, the end cover assembly 30 is secured to the casing 12 to cap the back end of the combustion chamber. The end cover assembly 30 includes an end cover plate 32 secured to the back end of the combustion chamber. The fuel nozzles 14 are bolted to the hot side (inward side) of the end cover plate 32. The end cover plate 32 is a one-piece member and includes fuel channels 34 therein that are sized and positioned to interact with fuel nozzle inlet ports of the plurality of fuel nozzles 14.

A monolith block 36 is secured to the end cover plate 32. The monolith block 36 is bolted to a center of the end cover plate 32 on the cold side (outward side) of the cover. The monolith block 36 uses internal flow passages 38 to transfer multiple gas inlet connections to the respective fuel nozzle connections. That is, the fuel gas passages 38 are positioned relative to the fuel channels 34 in the end cover plate 32 to commute fuel gas to the fuel channels 34 of the end cover plate 32, which in turn connect to the fuel nozzles.

In a preferred construction, the monolith block includes three fuel gas inlets 40, 42, 44 fluidly connected to respective ones of fuel nozzle inlet ports. With the combustion chamber including five outer fuel nozzles surrounding a center fuel nozzle, a first one 40 of the three fuel gas inlets may be connected to the center nozzle, a second one 42 of the three fuel gas inlets may be connected to two of the five outer nozzles, and a third one 44 of the three fuel gas inlets may be connected to the remaining three of the five outer nozzles. As shown, the three fuel gas inlets 40, 42, 44 may be staggered to enable an application of fuel gas at different load conditions. That is, the three premix fuel inlet ports 40, 42, 44 allow the gas fuel to be metered for differing modes of operation.

The first inlet 40 is generally used at start up when the engine is cold. The second inlet 42 is used for a 40-60% load condition and during start up. The fuel nozzles of the second inlet 42 are aligned radially and the second inlet 42 combustion zones are commuted from can-to-can using cross fire tubes to ensure all combustion cans are fired. The third inlet 44 is used for roughly 50-80% load conditions. Running the second and third inlets 42, 44 combined is used for roughly 80% to full load with the option to add the first inlet 40 for additional power.

Differing fuel mixtures and fuel rates with the three inlet connections 40, 42, 44 are used to adjust operating conditions to account for partial load, cold or hot day inlet air conditions, etc. Note that alternately additional premix connections could be added to the monolith block 36 and/or the monolith block 36 could be used in conjunction with conventional end cover assemblies to add fuel connection flexibility. The invention should not be limited to only three premix fuel connections as additional premix connections are possible.

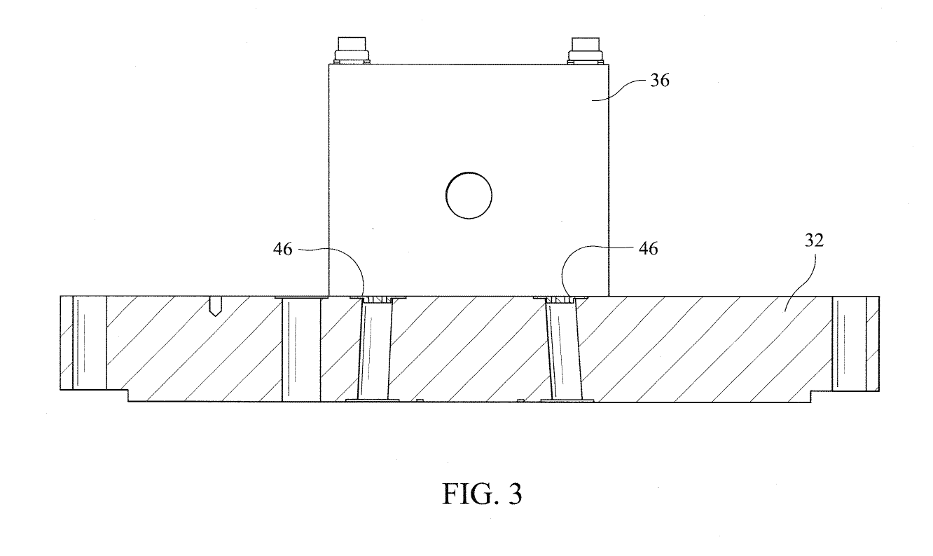

As shown in FIG. 3, the end cover assembly may additionally include interface seals 46 between the end cover plate 32 and the monolith block 36. The interface seals 46 provide a method to seal the premix fuel joint between the monolith 36 and end cover plate 32. It may be possible to develop a monolith design with adequate metal to metal interface surface contact to negate the need for a dedicated seal at the interface. Alternatively, a gasket type seal could be used over the entire monolith to end cover plate interface region.

By using the end cover plate 32 and monolith block 36 to define the end cover assembly 10, the end cover plate 32 can be constructed without welded gas passage plates and/or without brazed flow passage inserts. The resulting simplified construction reduces manufacturing costs and improves long-term durability.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. An end cover assembly for capping a back end of a combustion chamber, the end cover assembly comprising:
an end cover plate securable to the back end of the combustion chamber, the end cover plate being a one piece member with fuel channels therethrough, the fuel channels being sized and positioned to interact with fuel nozzle inlet ports; and
a monolith block secured to the end cover plate, the monolith block comprising internal fuel gas passages positioned relative to the fuel channels in the end cover plate to commute fuel gas to the fuel channels of the end cover plate.

2. An end cover assembly according to claim 1, wherein the monolith block comprises three fuel gas inlets fluidly connectable with respective ones of the fuel nozzle inlet ports.

3. An end cover assembly according to claim 2, wherein the combustion chamber includes five outer nozzles surrounding a center nozzle, and wherein a first one of the three fuel gas inlets is positioned to be connectable to the center nozzle, a second one of the three fuel gas inlets is positioned to be connectable to two of the five outer nozzles, and a third one of the three fuel gas inlets is positioned to be connectable to three of the five outer nozzles.

4. An end cover assembly according to claim 2, wherein the three fuel gas inlets are staggered to enable an application of fuel gas at different load conditions.

5. An end cover assembly according to claim 1, further comprising interface seals between the end cover plate and the monolith block.

6. An end cover assembly according to claim 1, wherein at least one of the interface seals comprises a gasket seal.

7. An end cover assembly according to claim 1, wherein the end cover plate is constructed without welded gas passage plates and without brazed flow passage inserts.

8. A gas turbine combustor comprising:
a casing including a combustion chamber;
a plurality of fuel nozzles disposed in the casing adjacent the combustion chamber; and
an end cover assembly secured to the casing and capping a back end of the combustion chamber, wherein the end cover includes:
an end cover plate secured to the back end of the combustion chamber, the end cover plate being a one piece member with fuel channels therethrough, the fuel channels being sized and positioned to interact with fuel nozzle inlet ports of the plurality of fuel nozzles, and
a monolith block secured to the end cover plate, the monolith block comprising internal fuel gas passages positioned relative to the fuel channels in the end cover plate to commute fuel gas to the fuel channels of the end cover plate.

9. A gas turbine combustor according to claim 8, wherein the monolith block comprises three fuel gas inlets fluidly connected to respective ones of the fuel nozzle inlet ports.

10. A gas turbine combustor according to claim 9, wherein the combustion chamber includes five outer nozzles surrounding a center nozzle, and wherein a first one of the three fuel gas inlets is connected to the center nozzle, a second one of the three fuel gas inlets is connected to two of the five outer nozzles, and a third one of the three fuel gas inlets is connected to three of the five outer nozzles.

11. A gas turbine combustor according to claim 9, wherein the three fuel gas inlets are staggered to enable an application of fuel gas at different load conditions.

12. A gas turbine combustor according to claim 8, wherein the end cover assembly further comprises interface seals between the end cover plate and the monolith block.

13. A gas turbine combustor according to claim 8, wherein the end cover plate is constructed without welded gas passage plates and without brazed flow passage inserts.

14. An end cover assembly in combination with a gas turbine combustor for capping a back end of a combustion chamber, the end cover comprising:
an end cover plate securable to the back end of the combustion chamber, the end cover plate being constructed without welded gas passage plates and without brazed flow passage inserts and including fuel channels therethrough, the fuel channels being sized and positioned to interact with fuel nozzle inlet ports; and
a monolith block secured to the end cover plate, the monolith block comprising internal fuel gas passages positioned relative to the fuel channels in the end cover plate to commute fuel gas to the fuel channels of the end cover plate.

15. An end cover assembly according to claim 14, wherein the monolith block comprises a plurality of fuel gas inlets fluidly connectable with respective ones of the fuel nozzle inlet ports.

16. An end cover assembly according to claim 15, wherein the plurality of fuel gas inlets are staggered to enable an application of fuel gas at different load conditions.
